(19) United States
(12) Patent Application Publication
(10) Pub. No.: US 2004/0258924 A1
(43) Pub. Date: Dec. 23, 2004

(54) Composite systems for in-mold decoration

(76) Inventors: Armin Berger, Langenfeld (DE); Bernd Post, Moers (DE); Jurgen Winkler, Langenfeld (DE); Jorg Nickel, Dormagen (DE)

Correspondence Address: BAYER MATERIAL SCIENCE LLC, 100 BAYER ROAD, PITTSBURGH, PA, 15205, US

(21) Appl. No.: 10/868,365

(22) Filed: Jun. 15, 2004

(30) Foreign Application Priority Data
Jun. 18, 2003 (DE) 10327453.7

(51) Int. Cl. B29D 22/00; B29D 23/00; B32B 27/00; B32B 27/40

(52) U.S. Cl. 428/423.1

(57) ABSTRACT

A composite systems (film laminates) useful for the in-mould decoration (IMD) process is disclosed. The composite comprise a first thermoplastic translucent plastics film having a thickness of from 20 to 1000 μm, a primer layer having a layer thickness of from 0.5 to 20 μm, a colored layer containing pigments and a plastics binder, and optional a second primer layer having a layer thickness of from 0.5 to 20 μm, which may be different from B), a layer of a thermoplastic polyurethane having a Shore A hardness of from 55 to 95, and a thermoplastic plastics film having a thickness of from 20 to 1000 μm, which may be different from the first plastic film.

### FIELD OF THE INVENTION

The invention relates to composite systems (film laminates), in particular film laminates mold useful in the context of in-mold decoration (IMD) process.

### SUMMARY OF THE INVENTION

A composite systems (film laminates) useful for the in-mold decoration (IMD) process is disclosed. The composite comprise a first thermoplastic translucent plastics film having a thickness of from 20 to 1000 μm, a primer layer having a layer thickness of from 0.5 to 20 μm, a colored layer containing pigments and a plastics binder, and optional a second primer layer having a layer thickness of from 0.5 to 20 μm, which may be different from B), a layer of a thermoplastic polyurethane having a Shore A hardness of from 55 to 95, and a thermoplastic plastics film having a thickness of from 20 to 1000 μm, which may be different from the first plastic film.

### BACKGROUND OF THE INVENTION

In the IMD process transparent plastics films, in particular PC films, are printed on their reverse predominantly by the screen printing process, are optionally bonded to a further film, are generally subsequently formed, are afterwards placed in an injection molding tool and are then back-filled with a thermoplastic plastics material in order to obtain ready decorated moldings.

This process is used, for example, for the production of decorated or symbol-bearing plastics parts—also with the back-lighting technique—in motor cars, inter alia for switch covers, parts for fittings, screens for fittings, and decorative strips, as well as for telecommunications moldings such as mobile phones, housings, keyboards and switch pads and keys, as well as for moldings for household appliances and other electronic equipment.

The stress which results from back-filling, also called back-molding (the term “back-filling” as used in the present context refers to the filling, such as by injection, of a mold with thermoplastic molding composition, the mold including a pre-positioned decorating film), particularly due to heat and mechanical shear, is particularly demanding of the decoration and, furthermore, of the adhesion of the back-filled thermoplastic to the decoration. DE-A 44 24 106 describes a layer structure in which a thermo-plastic layer is used which is bonded to the colored layer with a polyurethane adhesive in order to protect the decoration.

Such bonded laminates have the disadvantage that they can be produced only in conventional printing processes, in particular the screen printing process, with particularly stable, air-drying and solvent-containing or UV-curing and acrylate-containing screen printing inks. It is unavoidably necessary in these conventional non-digital processes to produce a printing screen, a printed image or a gravure cylinder, which means that a minimum number of prints is fundamental to the economics of the plastics components produced by the IMD technique.

When digital printing techniques are used in which low-melting point colored layers are applied by means of electrostatic forces, they must be particularly protected from the stresses caused by back-filling with thermoplastics which have higher melting points.

These low-melting point colored layers are moreover incompatible with the known hot melt adhesives, such that a film composite having adequate adhesion strength cannot be obtained.

### DETAILED DESCRIPTION OF THE INVENTION

The object of the present invention was therefore to provide a composite which enables the film to be printed and decorated by a digital, electrostatic printing process, which is stable to back-filling with thermoplastics which have higher melting points, and which furthermore has good lamination strength.

This objective is enabled by means of the composite system according to the invention.

The invention provides a composite system (laminate) which may be utilized for the production of digitally decorated plastics moldings by the IMD process, comprising

A) a thermoplastic translucent plastics film of a thickness of from 20 to 1000 μm,

B) a primer layer having a thickness of from 0.5 to 20 μm,

C) a colored layer with a low-melting point, preferably having a thickness of from 0.5 to 80 μm, containing at least one pigment and a plastics binder having a softening point below the softening point of the plastics film A),

D) optionally a second primer layer having a thickness of from 0.5 to 20 μm, which may be different from B),

E) a layer of a thermoplastic polyurethane having a Shore A hardness of from 55 to 95 and an ultimate tensile strength greater than 15 MPa (ISO 37), which is a reaction product of an organic diisocyanate (a), at least one Zerewitinoff-active polymeric diol having on average a minimum of 1.8 to a maximum of 2.5 Zerewitinoff-active hydrogen atoms and having a number average molecular weight of from 600 to 5000 g/mol (b) and at least one Zerewitinoff-active diol having on average a minimum of 1.8 to a maximum of 2.5 Zerewitinoff-active hydrogen atoms and having a number average molecular weight of from 60 to 500 g/mol as a chain extender (c), wherein the molar ratio of the NCO groups of the diisocyanate (a) to the Zerewitinoff-active hydrogen atoms from (b) and (c) is from 0.9 to 1.2, preferably 0.95 to 1.1,

F) a thermoplastic plastics film having a thickness of from 20 to 1000 μm, preferably 50 to 500 μm, which may be different from (A).

The composite system may also consist of the films/layers named above, but in the following sequence: A), E), D), C), B), F).

The invention also provides a molding comprising the composite system (film laminates) as described above and a back-filled thermoplastic plastics material.

The invention also provides a process for the production of the composite system according to the invention, which is characterized in that

a) a primer layer (B) is applied to a thickness of from 0.5 to 20 μm to a translucent thermoplastic plastics film (A) having a thickness of from 20 to 1000 μm,

b) by means of an electrostatic printing process a colored layer (C) is then applied, preferably to a thickness of from 0.5 to 80 μm, in the form of liquid dyes or inks based on pigments and plastics binders having a softening point below the softening point of the plastics film (A),

c) optionally a second primer layer (D) which may be different from the first primer layer (B) is applied to a thickness of from 0.5 to 20 μm,

d) a thermoplastic plastics film (F) having a thickness of from 20 to 1000 μm, preferably 50 to 500 μm, which is coated with thermoplastic polyurethane (E) is laminated to the layer system consisting of (A), (B), (C) and optionally (D), wherein a primer layer (D) is optionally present additionally on this TPU-coated plastics film.

The invention also provides a process for the production of the composite system according to the invention, which is characterised in that

a) a primer layer (B) is applied to a thickness of from 0.5 to 20 μm to a thermoplastic plastics film (F) having a thickness of from 20 to 1000 μm,

b) by means of an electrostatic printing process a colored layer (C) is then applied afterwards, preferably to a thickness of from 0.5 to 80 μm, in the form of liquid dyes or inks based on pigments and plastics binders having a softening point below the softening point of the plastics film (A),

c) optionally a second primer layer (D) which may be different from the first primer layer (B) is applied to a thickness of from 0.5 to 20 μm,

d) a thermoplastic translucent plastics film (A) having a thickness of from 20 to 1000 μm, preferably 50 to 500 μm, which is coated with thermoplastic polyurethane (E) is laminated to the layer system containing (F), (B), (C) and optionally (D), wherein a primer layer (D) is optionally present additionally on this TPU-coated plastics film.

The invention also provides a process for the production of the molding according to the invention, which is characterised in that

i) the composite system (film laminate) according to the invention is optionally formed,

ii) the protruding residues of the formed composite system (film laminate) are optionally trimmed,

iii) the composite system (laminate) is back-filled with a thermoplastic plastics material.

The plastics film (A) and the plastics film (F) preferably contain polycarbonate (PC), polyester carbonate (PEC), acrylonitrile-butadiene-styrene (ABS), styrene-acrylonitrile (SAN), polybutylene terephthalate (PBT), polyethylene terephthalate (PET), polyethylene glycol naphthalate (PEN), polytrimethylene glycol naphthalate (PMN), polymethyl methacrylate (PMMA), amorphous polyamide (PA), polyvinylchloride (PVC), polyether sulfone (PES), polyaryl sulfone (PAR), polysulfone (PSU), polyether imide (PEI), cyclo olefins (COC), aliphatic polyketones, blends thereof or copolymers of these plastics materials. Products from the named substance groups, which are transparent are preferred. PC, PC-PBT blends and PC-PET blends are particularly preferably utilized as the plastics material.

In the composite system according to the invention a primer (B) is applied to the translucent plastics film. This primer B) and primer D) preferably contain a copolyamide based on dimeric fatty acids. The primer is preferably present as a solution or dispersion of a so-called hot melt adhesive (for example Makromelt® 6239 from Henkel) in an organic solvent, preferably n-propanol, at a concentration of from 5 to 20 vol. %. The dispersion or solution is applied once or more until a coating thickness of from 0.5 to 5 μm is preferably formed.

The colored layer (decoration layer) C) preferably contains pigments and a plastics binder. The preferred binders have a softening point below the softening point of the plastics film A) and below the processing temperature of the plastics material with which back-filling is effected in order to produce the molding. Preferred pigments are the ones used in electrostatic printing. These pigments are described in U.S. Pat. No. 5,407,771 (incorporated herein by reference), for example. The colored layer is produced by using the toner dispersions described in the aforementioned patent and the patents mentioned in the next paragraph.

Printing (creation of the colored layer) on the film which is pre-treated with the primer B) takes place preferably by the so-called electrostatic imaging process of Hewlett-Packard-Indigo using an “Omnius Multistream” machine (now: HP Indigo Press s2000). This printing is described in U.S. Pat. No. 4,842,974, U.S. Pat. No. 4,860,924, U.S. Pat. No. 4,980,256, U.S. Pat. No. 5,286,593 and U.S. Pat. No. 5,300,390, all incorporated herein by reference. The printing machine generates a printed image on a photosensitive electronic image drum and transfers the part image (in one of each of the process colors (Y,M,C,K), or spot color, per revolution) onto an intermediate substrate. This intermediate substrate collects all the colored layers (up to 16 colored layers) before they are transferred in a single step to the substrate—in this case the primer-treated film.

This film thus decorated is then preferably protected for use in the IMD process, in particular from the stresses (heat and shear) of back-filling with high melting point thermoplastics, such as, for example, PC. The print is preferably protected with a thermoplastic film (F). This film is coupled with the composite produced from (A), (B), (C) and optionally (D) in a solid composite by way of the layer (E) having 8 N/mm minimum adhesion. The layer (E) preferably contains an extruded layer of TPU which is prepared from organic diisocyanates (a), polymeric diols (b) and diol chain extenders (c).

Aliphatic, cycloaliphatic, araliphatic, heterocyclic and aromatic diisocyanates, for example, as described in Justus Liebig's Annalen der Chemie, 562, pp. 75-136, are considered as the organic diisocyanates (a). The following might be named individually by way of example: aliphatic diisocyanates such as hexamethylene diisocyanate, cycloaliphatic diisocyanates such as isophorone diisocyanate, 1,4-cyclohexane diisocyanate, 1-methyl-2,4-cyclohexane diisocyanate and 1-methyl-2,6-cyclohexane diisocyanate as well as the corresponding isomer mixtures, 4,4′-dicyclohexylmethane diisocyanate, 2,4′-dicyclohexylmethane diisocyanate and 2,2′-dicyclohexylmethane diisocyanate as well as the corresponding isomer mixtures, aromatic diisocyanates such as 2,4-tolylene diisocyanate, mixtures of 2,4-tolylene diisocyanate and 2,6-tolylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-diphenylmethane diisocyanates, 4,4′-diisocyanatodiphenylethane-(1,2) and 1,5-naphthylene diisocyanate. The following are preferably used: 1,6-hexamethylene diisocyanate, isophorone diisocyanate, dicyclohexyl-methane diisocyanate, diphenylmethane diisocyanate isomer mixtures having a 4,4′-diphenylmethane diisocyanate content of>96 wt. % and in particular 4,4′-diphenylmethane diisocyanate and 1,5-naphthylene diisocyanate. The named diisocyanates may be used singly or in the form of mixtures with one another. They may also be used together with up to 15 wt. % (in relation to the total quantity of diisocyanate) of a polyisocyanate, for example triphenylmethane-4,4′,4″-triisocyanate or polyphenyl-polymethylene polyisocyanates.

Linear hydroxyl-terminating polyols having a molecular weight of from 600 to 5000 are utilized as the polymeric diol (b). As a result of the method of their production these frequently contain small quantities of non-linear compounds. The phrase “substantially linear polyols” is therefore also frequently used. Polyester diols, polyether diols, polycarbonate diols or mixtures thereof are preferred.

Suitable polyether diols may be prepared by reacting one or more alkylene oxides having 2 to 4 carbon atoms in the alkylene radical with a starter molecule which comprises two bound active hydrogen atoms. The following might be named as examples of alkylene oxides: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide are preferably utilized. The alkylene oxides may be used singly, in alternating sequence or as mixtures. The following are considered, for example, as starter molecules: water, aminoalcohols such as N-alkyldiethanolamines, for example N-methyldiethanolamine, and diols such as ethylene glycol, 1,3-propylene glycol, 1,4-butanediol and 1,6-hexanediol. Mixtures of starter molecules may optionally also be utilized. Suitable polyether diols are furthermore the hydroxyl group-containing polymerisation products of tetrahydrofuran. Trifunctional polyethers may also be utilized in proportions of from 0 to 30 wt. %, in relation to the difunctional polyethers, the maximum quantity thereof being, however, such that a thermo-plastically processable product results. The substantially linear polyether diols have molecular weights of from 600 to 5000. They may be used both singly and also in the form of mixtures with one another.

Suitable polyester diols may be prepared, for example, from dicarboxylic acids having 2 to 12 carbon atoms, preferably 4 to 6 carbon atoms, and polyhydric alcohols. The following are considered, for example, as the dicarboxylic acids: aliphatic dicarboxylic acids such as succinic acid, glutaric acid, adipic acid, suberic acid, azelaic acid and sebacic acid and aromatic dicarboxylic acids such as phthalic acid, isophthalic acid and terephthalic acid. The dicarboxylic acids may be used singly or as mixtures, for example in the form of a succinic, glutaric and adipic acid mixture. In order to prepare the polyester diols it may optionally be advantageous to use in place of the dicarboxylic acids the corresponding dicarboxylic acid derivatives such as carboxylic acid diesters having 1 to 4 carbon atoms in the alcohol radical, carboxylic acid anhydrides or carboxylic acid chlorides. Examples of polyhydric alcohols are glycols having 2 to 10, preferably 2 to 6 carbon atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol and dipropylene glycol. Depending on the desired properties, the polyhydric alcohols may be used alone or optionally in mixture with one another. Esters of carbonic acid with the named diols, in particular those such as have 4 to 6 carbon atoms, such as 1,4-butanediol or 1,6-hexanediol, condensation products of hydroxycarboxylic acids, for example hydroxycaproic acid and polymerisation products of lactones, for example optionally substituted caprolactones, are furthermore suitable. The following are preferably used as the polyester diols: ethanediol polyadipates, 1,4-butanediol polyadipates, ethane-1,4-butanediol polyadipates, 1,6-hexanediol neopentyl glycol polyadipates, 1,6-hexanediol-1,4-butanediol polyadipates and polycaprolactones. The polyester diols have molecular weights of from 600 to 5000 and may be used singly or in the forms of mixtures with one another.

Diols having molecular weights of from 60 to 500, preferably aliphatic diols having 2 to 14 carbon atoms, such as, for example, ethanediol, 1,6-hexanediol, diethylene glycol, dipropylene glycol and in particular 1,4-butanediol, are utilized as the chain extenders (c). However, diesters of terephthalic acid with glycols having 2 to 4 carbon atoms, such as, for example, terephthalic acid bisethylene glycol or terephthalic acid bis-1,4-butanediol, hydroxyalkylene ethers of hydroquinone, such as, for example, 1,4-di(hydroxyethyl) hydroquinone, ethoxylated bisphenols, are also suitable. Mixtures of the chain extenders named above may also be utilized. Relatively small quantities of triols may also be added.

Conventional monofunctional compounds may also be utilized in small quantities, for example as chain terminators or mold release agents.

Alcohols such as octanol and stearyl alcohol or amines such as butylamine and stearylamine might be named by way of example.

In order to prepare the TPUs the reactants may, optionally in the presence of catalysts, auxiliary substances and additives, be reacted in quantities such that the equivalent ratio of NCO groups to the sum of NCO-reactive groups, in particular of the OH groups of the low molecular weight diols/triols and polyols is from 0.9:1.0 to 1.2:1.0, preferably 0.95:1.0 to 1.10:1.0.

Suitable catalysts for the production of the TPU are the conventional tertiary amines which are known from the prior art, such as, for example, triethylamine, dimethylcyclohexylamine, N-methylmorpholine, N,N′-dimethyl piperazine, 2-(dimethylaminoethoxy) ethanol, diazabicyclo-(2,2,2) octane and the like, as well as in particular organic metal compounds such as titanic acid esters, iron compounds, tin compounds, for example tin diacetate, tin dioctoate, tin dilaurate or the tin dialkyl salts of aliphatic carboxylic acids, such as dibutyltin diacetate, dibutyltin dilaurate or the like. Preferred catalysts are organic metal compounds, in particular titanic acid esters, iron compounds or tin compounds.

In addition to the TPU reactants and the catalysts, other auxiliary substances and additives may also be added. The following might be named by way of example: lubricants such as fatty acid esters, metallic soaps thereof, fatty acid amides and silicone compounds, anti-blocking agents, inhibitors, hydrolysis, light, heat and discoloration stabilisers, flame retardants, dyes, pigments, inorganic or organic fillers and reinforcing agents. Reinforcing agents are in particular fibrous reinforcing materials such as inorganic fibres and may also be provided with a size. More detailed information regarding the named auxiliary substances and additives may be found in the specialist literature, for example J. H. Saunders, K. C. Frisch: “High Polymers”, Vol. XVI, Polyurethane, Parts 1 and 2, Interscience Publishers 1962 and 1964,

R. Gächter, H. Müller (Ed.): Taschenbuch der Kunststoff-Additive, 3^{rd} edition, Hanser Verlag, Munich 1989, or DE-A 29 01 774.

Further additives which may be incorporated in the TPU are thermoplastics, for example polycarbonates and acrylonitrile-butadiene-styrene terpolymers, in particular ABS. Other elastomers such as rubber, ethylene-vinyl acetate copolymers, styrene-butadiene copolymers as well as other TPUs may likewise be used. Conventional commercial plasticisers such as phosphates, phthalates, adipates, sebacates and alkylsulfonic acid esters are furthermore suitable to be incorporated.

The TPUs are prepared without the addition of solvents, in discontinuous or continuous manner. In continuous manner, the TPUs according to the invention may be prepared, for example, by the mixing head/belt process or the so-called extruder process. In the extruder process, for example in a multi-screw extruder, the components a), b) and c) may be dispensed simultaneously, that is to say in a one-shot process, or sequentially, that is to say by a prepolymer process. Here, the prepolymer may take the form of a batch and may also be prepared in continuous manner in part of the extruder or in a separate upstream prepolymer unit.

The TPUs have a Shore A hardness (ISO 868) of from 55 to 95 and an ultimate tensile strength greater than 15 MPa (ISO 37).

Particularly preferably, a film (F) which already has the layer (E) applied is used for the lamination of the decorated composite produced from (A), (B), (C) and optionally (D). During production, a TPU film is taken, and the thermoplastic of the film (F) is then extruded-on in the desired thickness. It is also feasible that a film (F) is taken, and the TPU is then extruded-on in the desired thickness. Co-extrusion of the TPU and the thermoplastic of the film (F) is likewise possible.

The film (F) which is preferably already coated with the TPU may optionally be provided additionally with a primer on the TPU.

The transparent, primed and printed film is preferably laminated together with the TPU-coated film at temperatures of between 110 and 140° C., preferably 120 to 130° C. A solid composite system having a very high lamination strength is obtained.

The three-dimensional forming of films or composite systems prior to back-filling is characteristic of the IMD process. The composite system according to the invention is preferably formed at moderate temperatures, as, for example, in embossing or by means of the so-called “high-pressure forming” process (DE-A 3 844 584 and U.S. Pat. No. 5,108,530 incorporated herein by reference). The forming of the composite system preferably takes place at below the softening point of the film (A), such that its texturing is retained and the printed layer is not impaired.

After forming, the composite systems according to the invention are preferably separated from protruding parts by stamping, trimming, laser cutting, water jet cutting or milling in accordance with their molding contour.

The molded and cut composite system is subsequently placed in an injection molding tool and is back-filled with thermoplastic plastics material, preferably PC or a blend of PC and ABS. A ready decorated plastics molding is obtained.

The composite systems according to the invention or the plastics moldings produced from them may be used as keys, switches and fittings, in particular in the automobile sector and the electronics sector, for example for switch covers, parts for fittings, screens for fittings, and decorative strips, as well as for telecommunications moldings such as mobile phones, housings, keyboards and switch pads and keys, as well as moldings for household appliances and other electronic equipment, as well as for advertising panels and packaging articles.

The invention is to be explained in greater detail by reference to the Examples which follow.

### EXAMPLES

### Example a)

A polycarbonate film (Makrofol® DE 14 from Bayer AG) having a thickness of 0.175 mm was provided with a primer (Topaz from Hewlett-Packard Company, Maastricht) to a thickness of 0.001 mm.

Colored printed fields were then printed on the film in the 4 primary colors yellow (Y), magenta (M), cyan (C) and black (K) by means of an HP Indigo Press s2000 machine. The thickness of the colored layer was between 0.001 and 0.009 mm.

The printed films were placed in an injection molding tool and were back-filled.

Process parameters:

| | |
|---|---|
| Mold: | 75 × 155 mm sheet |
| Thickness: | adjusted to 2.4 mm |
| Sprue: | central sprue gate, 8 mm diameter |
| Back-filling: | with polycarbonate (Makrolon ® 2400 from |
| | Bayer AG) |
| Melting temperature: | 290° C. |
| Mold temperature: | 80° C. |
| Screw diameter: | 25 mm |
| Injection rate: | 38 mm/sec |
| Injection time: | 1.8 sec |

Result:

After back-filling with the polycarbonate the molding showed large areas where the color had been washed out. The printed image was completely destroyed.

### Example b)

The experiment was carried out as described under a), with the difference that in addition to the digitally applied colored layer of the outer film a further layer of the primer Topaz was applied to the colored layer to a thickness of 0.001 and 0.002 mm. In order to protect the decoration a polycarbonate film having a wall thickness of 0.175 mm (Makrofol® DE 1-4 from Bayer AG) was laminated-on. This protective film had previously been coated by screen printing with an adhesive to a thickness of approximately 15 μm. The adhesive used was Aquapress®ME from Pröll, Weissenburg/Bavaria (aqueous anionic dispersion of high molecular weight cross-linked polyester polyurethane).

Parameters during lamination:

| | |
|---|---|
| Hot press: | from Bürkle |
| Temperature: | 120° C. |
| Contact pressure: | 33 bar |
| Pressing cycle: | 20 min |

Result:

After back-filling, the molding showed large areas where the color had been washed out, despite the protective film. The printed image was destroyed. The lamination strength of the film composite was inadequate. The film composite could be pulled apart in the tensile test, with the colored layer fanning out and remaining both on the outer film and on the protective film.

### Example c)

The experiment was carried out as described under b), but a different injection molding tool was used; and the wall thickness of the protective film was 0.2 mm:

| | |
|---|---|
| Mold: | 99 mm × 129 mm sheet |
| Thickness: | adjusted to 3 mm |
| Sprue: | Film gate on narrow side, 99 mm × |
| | 1.8 mm thickness |
| Back-filling: | with polycarbonate (Makrolon ® 2400 |
| | from Bayer AG) |
| Melting temperature: | 290° C. |
| Mold temperature: | 60° C. |
| Injection time: | 1.67 sec |

Result:

After back-filling, although no color had washed out nor any other color changes taken place in the molding, the lamination strength was still inadequate.

### Example d)

### According to the Invention

A polycarbonate film (Makrofol® DE 1-4 from Bayer AG) having a thickness of 0.175 mm was provided with a primer (Topaz from Hewlett-Packard Company, Maastricht) to a thickness of 0.001 mm.

Colored printed fields were then printed on the film in the 4 primary colors yellow (Y), magenta (M), cyan (C) and black (K) at different opacities. The thickness of the colored layer was between 0.002 and 0.008 mm. An additional layer of the primer (Topaz® from Hewlett-Packard Company) was applied to a thickness of approximately 0.002 mm on the colored layer.

In parallel to this, a 0.1 mm thick polycarbonate film (Makrofol® DE 6-2 from Bayer AG) was provided with a 0.025 mm thick layer of a TPU having a Shore A hardness of 70 (Desmopan® KU2-8670 from Bayer AG).

The two thus prepared films were laminated together as described under b).

Parameters:

| | |
|---|---|
| Hot press: | Bürkle |
| Temperature: | 120° C. |
| Contact pressure: | 33 bar |
| Pressing cycle: | 20 min |

The composite system was placed in an injection molding tool and was back-filled as described under a).

Result:

The lamination strength was so good that the protective film tore in preference to the composite of TPU layer/primer/colored layer. After back-filling, the printed image/the decoration was not damaged even though the protective film which was applied had been selected to be very thin and the direct sprue gate gave rise to particularly high stress on the laminate and the decoration.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Composite system comprising in sequence
A) a thermoplastic translucent plastics film having a thickness of from 20 to 1000 μm,
B) a primer layer having a layer thickness of from 0.5 to 20 μm,
C) a colored layer with a low melting point containing pigments and a plastics binder having a softening point below the softening point of the plastics film (A),
D) optionally a second primer layer having a layer thickness of from 0.5 to 20 μm, which may be different from B),
E) a layer of a thermoplastic polyurethane having a Shore A hardness of from 55 to 95 and an ultimate tensile strength greater than 15 MPa (ISO 37), which is a reaction product of an organic diisocyanate (a), at least one Zerewitinoff-active polymeric diol having on average a minimum of 1.8 to a maximum of 2.5 Zerewitinoff-active hydrogen atoms and having a number average molecular weight of from 600 to 5000 g/mol (b) and at least one Zerewitinoff-active diol having on average a minimum of 1.8 to a maximum of 2.5 Zerewitinoff-active hydrogen atoms and having a number average molecular weight of from 60 to 500 g/mol as a chain extender (c), wherein the molar ratio of the NCO groups of the diisocyanate (a) to the Zerewitinoff-active hydrogen atoms from (b) and (c) is from 0.9 to 1.2, preferably 0.95 to 1.1,
F) a thermoplastic plastics film having a thickness of from 20 to 1000 μm, which may be different from (A).

2. The composite system according to claim 1, wherein the sequence is A), E), D), C), B) and F).

3. A molding comprising
I) the composite system according to claim 1 and
II) a back-filled thermoplastic material.

4. A process for the production of the composite system according to claim 1, comprising
(a) applying the primer layer (B) having a thickness of from 0.5 to 20 μm to a translucent thermoplastic plastics film (A) having a thickness of from 20 to 1000 μm,
(b) applying to the surface of (B) by means of an electrostatic printing process a colored layer (C) in the form of liquid dyes or inks based on pigments and plastics binders having a softening point below the softening point of the plastics film (A) the layer having a thickness of from 0.5 to 80 μm,
(c) optionally applying to the surface of (C) a second primer layer (D) having a thickness of from 0.5 to 20 μm, said (D) being the same as or different from (B) to obtain a layer system comprising (A), (B), and (C), and the optional (D), and
(d) coating a thermoplastic plastics film (F) having a thickness of from 20 to 1000 μm, with thermoplastic polyurethane (E) and
(e) laminating the coated (F) to the layer system consisting of (A), (B), (C) and the optional (D).

5. A process for the production of the composite system according to claim 2, comprising
a) applying a primer layer (B) having a thickness of from 0.5 to 20 μm to a thermoplastic plastics film (F) having a thickness of from 20 to 1000 μm,
b) applying to the surface of (B) by means of an electrostatic printing process a colored layer (C) having a thickness of from 0.5 to 80 μm, said (C) containing at least one liquid dye or ink based on pigments and at least one plastics binder having a softening point below the softening point of the plastics film (A) and
c) optionally applying a second primer layer (D) having a thickness of from 0.5 to 20 μm to the surface of (C), said (D) being the same as of different from said layer (B), to form a layer system comprising (F), (B), (C) and optionally (D),
d) coating a thermoplastic translucent plastics film (A) having a thickness of from 20 to 1000 μm, with thermoplastic polyurethane (E) and
e) laminating to the layer system that comprise (F), (B), (C) and optionally (D), the coated plastics film (A).

6. A process for the production of the molding comprising
(i) obtaining and optionally forming the composite system according to claim 1,
(ii) positioning the composite system in a mold cavity and
(iii) back-filling the cavity with molten thermoplastic material.

7. A molded article comprising the composite system of claim 1.

8. A molded article comprising the composite system of claim 2.
